(19) United States
(12) Patent Application Publication
(10) Pub. No.: US 2016/0209986 A1
(43) Pub. Date: Jul. 21, 2016

(54) NOTIFICATIONS DISPLAY IN ELECTRONIC DEVICES

(71) Applicant: Microsoft Technology Licensing, LLC, Redmond, WA (US)

(72) Inventor: Frances Kim, Houston, TX (US)

(21) Appl. No.: 14/683,766

(22) Filed: Apr. 10, 2015

(30) Foreign Application Priority Data
Jan. 21, 2015 (CN) PCT/CN2015/071205

(51) Int. Cl. G06F 3/0481; G06T 13/00; G06F 3/0488; G06F 3/0484

(52) U.S. Cl. CPC G06F 3/0481; G06F 3/04842; G06T 13/00; G06F 3/04883; H04W 88/02

(57) ABSTRACT

The subject matter described herein relates to display of notifications in an electronic device having a display. In one embodiment, there is disclosed a method that comprises activating an interactive element in response to a contact operation of a user on the interactive element, said interactive element corresponding to an application in the electronic device. The method also comprises causing a notification associated with the application to be displayed in an area on the display, responsive to a movement operation of the user on the display, wherein the area is smaller than a full area of the display.

### RELATED APPLICATIONS

This application claims priority to International Application No. PCT/CN2015/071205, filed on Jan. 21, 2015, and entitled “NOTIFICATIONS DISPLAY IN ELECTRONIC DEVICES.” This application claims the benefit of the above-identified application, and the disclosure of the above-identified application is hereby incorporated by reference in its entirety as if set forth herein in full.

### BACKGROUND

Electronic devices, such as mobile devices and smart phones, play a more and more important role in modern lives. These electronic devices are capable of running various applications and enabling users to make/answer telephone calls, send/receive electronic mails, surf the internet, and text with friends and acquaintances or the like. When messages come in; incoming calls are missed; and applications update or other events occur on an electronic device, it is customary to generate notifications associated with the respective applications so as to inform users of the event occurrence. However, in some cases, users may not notice the notifications, possibly due to their devices being not around or muted, being busy or for other reasons. The users may later wish to have a quick review of the newly generated notifications or even earlier notifications associated with a specific application to see what has happened or whether anything important has been missed, without bothering to launch and access the application or switching among various applications.

The existing electronic devices, such as smart phones, provide several mechanisms for displaying notifications, for example by displaying icons indicative of the notifications, which may later direct users to access associated applications and then to view contents of the notifications, or by displaying the notifications in a quick or fast access screen, which usually occupies a full display screen of the smart phone, with a limited number of notifications associated with each application being displayed and latest notifications from different applications being lumped into this quick or fast access screen. For the latter case, if a user wishes to view more notifications associated with a specific application, he/she has to launch and access the specific application. In either case, a user may have to access an application if the user wants to get knowledge of most or all notifications associated with that application or of details of a particular notification.

### SUMMARY

An object of various embodiments of the subject matter described herein is to provide a mechanism for displaying notifications in relation with an individual application in an electronic device. The electronic device has a display on which one or more interactive elements may be displayed, each interactive element corresponding to an application. According to one embodiment, the interactive element corresponding to the application that a user may be interested is first activated by a contact operation of the user on this interactive element. Then, a notification associated with this application is displayed in an area on the display according to a movement operation of the user on the display. The area for displaying the notification is smaller than a full area of the display.

By virtue of this mechanism, users can view notifications associated with interested applications without launching and accessing the applications individually or switching among the applications. Latest notifications from different applications are not lumped into one quick or fast access screen, but neatly organized according to the corresponding interactive element's area on the electronic device.

Other features and advantages of embodiments of the subject matter described herein will also be understood from the following description of specific embodiments when read in conjunction with the accompanying drawings, which illustrate, by way of example, principles of embodiments of the subject matter described herein.

This Summary is provided to introduce a selection of concepts in a simplified form. The concepts are further described below in the Detailed Description. This Summary is not intended to identify key features or essential features of the claimed subject matters, nor is it intended to be used to limit the scope of the claimed subject matters.

### BRIEF DESCRIPTION OF THE DRAWINGS

Embodiments of the subject matter described herein are illustrated by way of example and not limited in the accompanying figures in which like reference numerals indicate similar elements and in which:

FIG. 1 schematically illustrates a block diagram of an electronic device in accordance with an embodiment of the subject matter described herein;

FIG. 2 illustrates a screen shot of a mobile device having a display on which a plurality of interactive elements each corresponding to an application is displayed;

FIG. 3 illustrates a series of screen shots of the mobile device as illustrated in FIG. 2 to illustrate a process for displaying notifications according to an embodiment of the subject matter described herein;

FIG. 4 illustrates two examples of a limited area for displaying notifications according to an embodiment of the subject matter described herein;

FIG. 5 illustrates a flowchart of an exemplary method for displaying notifications in an electronic device according to an embodiment of the subject matter described herein; and

FIG. 6 illustrates a block diagram of an exemplary apparatus for displaying notifications in an electronic device according to an embodiment of the subject matter described herein.

### DETAILED DESCRIPTION

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

References in the specification to “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be liming of the embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including” and variants thereof, when used herein, specify the presence of stated features, elements, and/or components etc., not precluding the presence or addition of one or more other features, elements, components and/or combinations thereof.

In the following description and claims, unless defined otherwise, all technical and scientific terms used herein have the same meaning as commonly understood by one of ordinary skills in the art to which this subject matter described herein belongs.

As can be seen from the Background, the existing mechanisms for displaying notifications usually occupy the full display screen of an electronic device, which may undesirably block other applications and cause notifications from different applications stacked together. Because of this exclusive occupation of the display screen, the user wishing to view notifications associated with different applications may have to frequently switch among these applications. In view of these, a new mechanism for displaying notifications in an electronic device is provided herein, which will be detailed in the following exemplary embodiments.

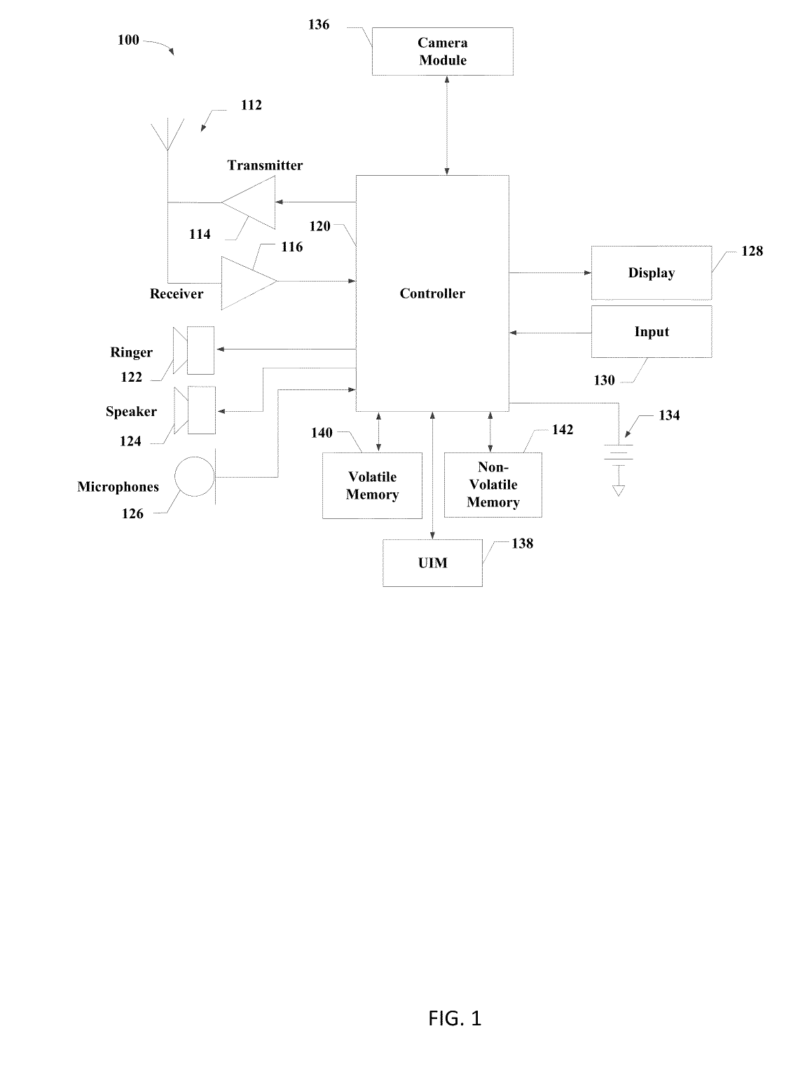

FIG. 1 illustrates a block diagram of an electronic device 100 in accordance with an embodiment of the subject matter described herein. In various embodiments, the electronic device may refer to any device capable of generating and displaying notifications, for example a mobile phone, a cellular phone, a smart phone, a pager, a personal digital assistant (PDA), a portable computer, a laptop, an image capturing device such as a digital camera, a gaming device, a music storage and playback appliance and the like. It is to be understood that in some embodiments, the electronic device 100 may be a fixed type machine such as a desktop personal computer (PC) or the like.

In one embodiment, the electronic device 100 may comprise one or more antennas 112 operable to communicate with a transmitter 114 and a receiver 116. The electronic device 100 may also comprise a controller 120. It shall be understood that the controller 120 comprises circuits or logic required to implement functions of the electronic device 100. For example, the controller 120 may comprise at least one processor, such as a digital signal processor, a microprocessor, an A/D converter, a D/A converter, and/or any other suitable circuits. The control and signal processing functions of the electronic device 100 are allocated in accordance with respective capabilities of these devices.

The electronic device 100 may further comprise a user interface, which, for example, may comprise a ringer 122, a speaker 124, a microphone 126, a display 128, and an input interface 130, and all of the above devices are coupled to the controller 120. The electronic device 100 may further comprise a camera module 136 for capturing static and/or dynamic images.

The electronic device 100 may further comprise a battery 134, such as a vibrating battery set, for supplying power to various circuits required for operating the electronic device 100 and alternatively providing mechanical vibration as detectable output. In an embodiment, the electronic device 100 may further comprise a user identification module (UIM) 138. The UIM 138 is usually a memory device with a processor built in. The UIM 138 may for example comprise a subscriber identification module (SIM), a universal integrated circuit card (UICC), a universal user identification module (USIM), or a removable user identification module (R-UIM), etc. The UIM 138 may comprise a card connection detecting apparatus according to embodiments of the subject matter described herein.

The electronic device 100 further comprises at least one memory. For example, the electronic device 100 may comprise a volatile memory 140, for example, comprising a volatile random access memory (RAM) in a cache area for temporarily storing data. The electronic device 100 may further comprise other non-volatile memory 142 which may be embedded and/or movable. The non-volatile memory 142 may additionally or alternatively include for example, EEPROM and flash memory, etc. The memory 140 may store any item in the plurality of information segments and data used by the electronic device 100 so as to implement the functions of the electronic device 110. The at least one memory may contain computer program code. The at least one memory and the computer program code are configured to, with the at least one processor as comprised in the controller, cause the electronic device to implement method 500 as described below.

It should be understood that the structural block diagram in FIG. 1 is shown only for illustrative purposes, without suggesting any limitations on the scope of the subject matter described herein. In some cases, some components may be added into or reduced from the electronic device 100 as required.

Hereafter, several embodiments of the subject matter described herein will be illustratively described in the context of mobile devices with a Metro User interface (UI). Those skilled in the art will appreciate, however, that the concept and principle of the several embodiments of the subject matter described herein may be more generally applicable to other electronic devices with different styles of interfaces.

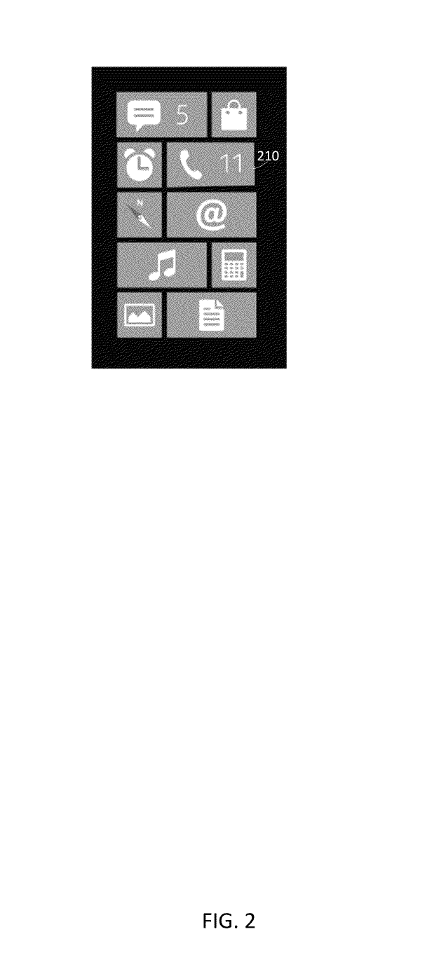

Referring now to FIG. 2, there is shown a screen shot of a mobile device having a display on which one or more interactive elements can be displayed. In the example shown in FIG. 2, a plurality of interactive elements are displayed, each corresponding to an application, such as an email application, a messaging application, a telephone application, an internet explorer, a music player, or the like. As used herein, the term “interactive element” refers to any element that can be visually rendered on the user interface of the electronic device and can be operated by a user. Each of the interactive elements may be, for example, a simple icon that represents the corresponding application or a tile that may have an icon shown thereon for representing the corresponding application and a spare space for displaying information related to the application when needed. The display may comprise a touch sensitive surface or panel, such as a resistive, capacitive, or inductive touch panel, to accept a user's operation via the user's finger or a pointing device, such as a stylus.

In one embodiment, a numeral may be displayed on an interactive element. Such a numeral reminds the user that there are new notifications generated for the corresponding application and meanwhile indicates a number of unread/read notifications associated with this application. It is possible to use such a numeral to only indicate the number of unread notifications or both the unread and read notifications, depending on particular implementations. For example, as illustrated in FIG. 2, a numeral 11 is displayed on the interactive element 210, which means there are newly generated notifications for the telephone application and meanwhile indicates 11 unread notifications associated with this application.

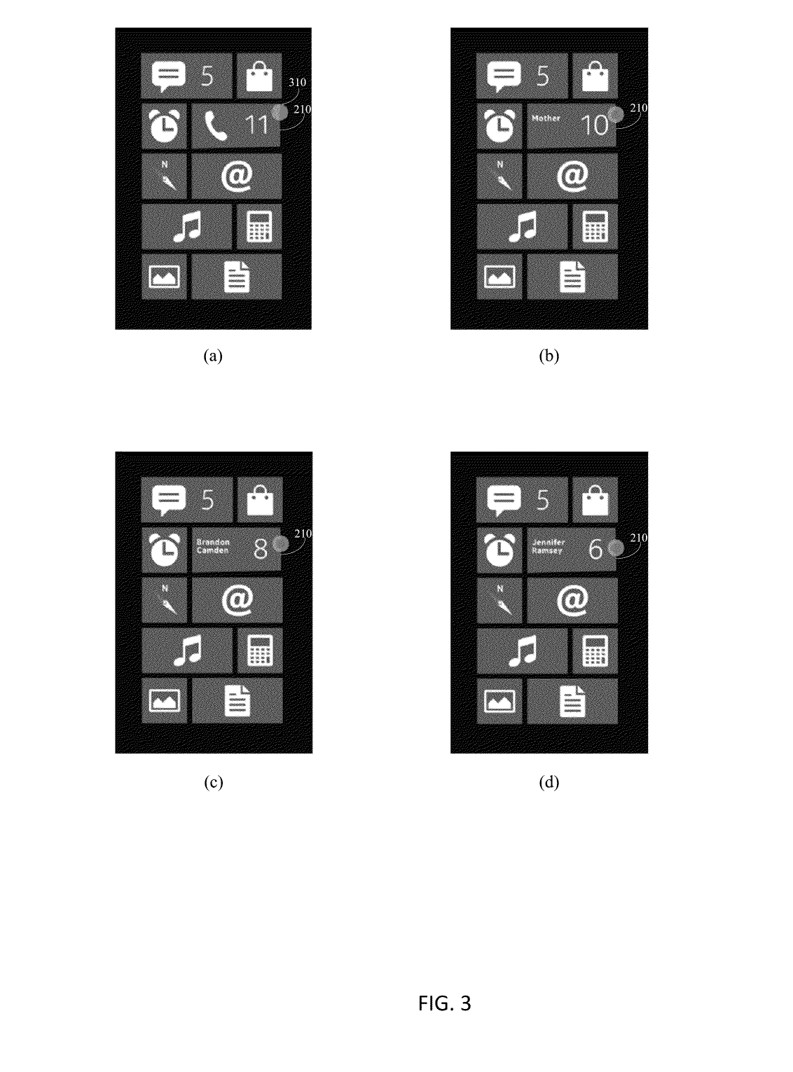

FIG. 3 exemplarily shows a series of screen shots of the mobile device as illustrated in FIG. 2 to illustrate a process for displaying notifications according to an embodiment of the subject matter described herein.

According to an embodiment of the subject matter described herein, when a user wants to view notifications associated with a specific application, e.g. the telephone application, he/she may perform a contact operation first, e.g. via his/her finger or a pointing device, on the interactive element corresponding to that specific application. In various embodiments, the contact operation may be a continuous press on the interactive element over a predefined period of time, e.g. 3 seconds, or drawing of a predetermined pattern, e.g. a zigzag pattern, on the interactive element. Other contact operations may also be possible, as long as they can activate an interactive element.

Specifically, FIG. 3(a) shows the contact operation performed on interactive element 210, which is activated accordingly. A circle (or any other visible indicator) 310 on the right edge of the interactive element 210 illustratively indicates a contact area of the user's finger or pointing device on the display when it continuously presses the interactive element 210. In one embodiment, the activated interactive element may show a different color from other interactive elements or appear brighter or higher than other interactive elements so as to indicate to the user that this interactive element has been activated and following operations on the display may be related to this interactive element only, for example.

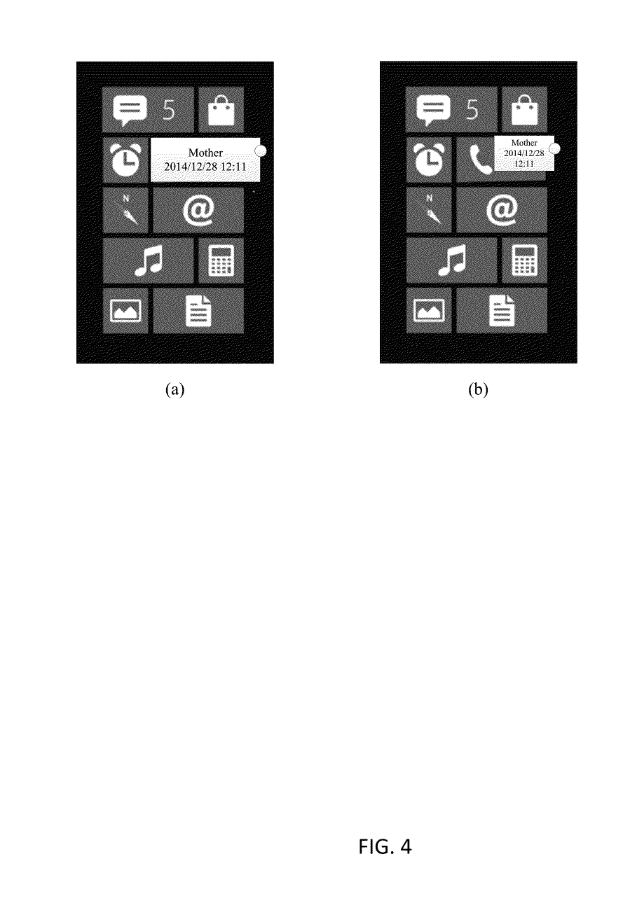

Upon the activation of the interactive element, the user may further perform a movement operation on the display to cause a notification(s) associated with the application corresponding to the activated interactive element to be displayed in an area on the display. Specifically, the area for displaying the notification is a limited area. That is to say, the limited area is smaller than a full area of the display. For example, when the activated interactive element is a tile, the limited area may be the spare space of the tile or an area replacing the icon within the tile, e.g. the area for displaying a notification regarding “Mother” as illustrated in the interactive element 210 of FIG. 3(b). Additionally, FIG. 4 shows other two examples of the limited area for displaying notifications. As shown in FIG. 4(a), the limited area may be an area defined by expanding the activated interactive element; or as shown in FIG. 4(b), the limited area may be an area within a pop up window over the activated interactive element.

The user may start this movement operation from any point on the display. By way of example, in one embodiment, the user may start the movement operation from a point along an edge of the activated interactive element, and then keep pressing the display with his/her finger or the pointing device and meanwhile move along a constant direction, for example, along an edge of the activated interactive element.

In an embodiment where the contact operation is a continuous press of a finger or a pointing device over a predefined period of time on the interactive element, the movement operation may be immediately performed without moving the finger or the pointing device off the display surface. For example, as shown in FIG. 3 (b), the finger or the pointing device pressing the display to activate the interactive element 210 may keep pressing and meanwhile move down along the right edge of the interactive element 210, which is illustrated with two nested circles in the figure. As the finger or the pointing device moves down along the edge, a notification, for example numbered 10, is displayed in the limited area replacing the telephone icon within the interactive element 210. Then as the finger or the pointing device keeps moving down, other notifications will be displayed within the limited area one by one with the numeral indicating the notification number decreasing. For example, FIG. 3(c) and FIG. 3(d) respectively show that notifications numbered 8 and 6 are displayed as the nested circles keep moving down relative to the position in FIG. 3(b).

In this embodiment as illustrated in FIG. 3, a partial content of each notification, e.g. notification 10 or 6, is displayed, i.e. only the caller's appellation or name is displayed. However, those skilled in the art shall appreciate that more information about the notifications, for example generation time of the notification, a location of the caller etc., may also be displayed in addition to the appellation or name. Furthermore, more than one notification may be displayed each time within the limited area, as long as the space of the limited area allows.

In a further embodiment, the user may select a notification currently displayed within the limited area, for example by double or multiple tapping on or long pressing the displayed notification so as to cause a full content of the selected notification to be displayed. In another embodiment, due to the space limitation of the limited area, the displayed notification may comprise text only which scroll across the limited area, e.g. automatically or responsive to the movement operation of the user on the display.

In a further embodiment, when the finger or the pointing device pressing the display moves up along the edge of the activated interactive element, the notifications may be displayed in an order reverse to the order that the notifications were displayed when the finger or the pointing device moving down. In this embodiment, the notifications may be displayed chronologically with the recently generated notification being displayed first as the pressing finger or pointing device moves down, while the recently generated notification is displayed last as the pressing finger or pointing device moves up.

In other embodiments, the finger or the pointing device may continuously press any portion of an interactive element over a predefined period of time to activate the interactive element and then keep pressing and move along the left, top or bottom edge of the interactive element or along any constant direction extending from the point where the finger or the pointing device initially presses and thereby achieve the same effect of displaying notifications as described above with reference to FIG. 3. The contact and movement operations performed in these embodiments are also similar to those as described above. Therefore, for the purpose of conciseness, these operations will not be detailed herein.

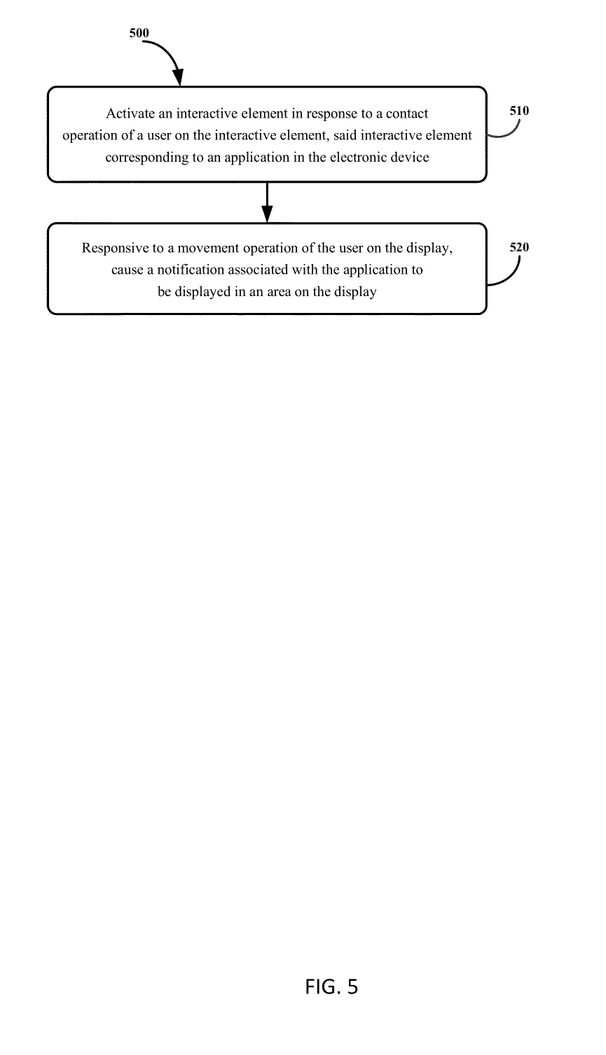

FIG. 5 illustrates a flowchart of an exemplary method 500 for displaying notifications in an electronic device, e.g. the electronic device 100 as illustrated in FIG. 1, according to an embodiment of the subject matter described herein. The electronic device comprises a display on which an interactive element(s) corresponding to an application(s) may be displayed.

The method 500 is entered at block 510 to activate an interactive element in response to a contact operation of a user on the interactive element. The contact operation may be a continuous press over a predefined period of time or drawing of a predetermined pattern, as described above.

Next, at block 520, the method 500 causes a notification associated with the application to be displayed in an area on the display, responsive to a movement operation of the user on the display. This area for displaying the notification is smaller than a full area of the display.

In an embodiment of the subject matter described herein, the displaying area may be an area within the activated interactive element, e.g. when the activated interactive element is a tile, or an area defined by expanding the activated interactive element or an area within a pop up window over the activated interactive element.

In another embodiment of the subject matter described herein, the movement operation may comprise pressing and moving along a constant direction on the display. For example, the movement operation may comprise pressing and moving along an edge of the activated interactive element.

In yet another embodiment of the subject matter described herein, after the movement operation is released, the displayed notification may further be displayed for a predefined period of time, e.g. for a few seconds. During the predefined period of time, the user may continue viewing the displayed notification or select the displayed notification, for example by double tapping on or long pressing it so that more content of the displayed notification may be presented; otherwise, as the predefined period of time expires, the activated interactive element will go back to its original state, i.e. the state before it is activated. In an embodiment that a numeral is displayed on the interactive element to indicate the number of unread notifications, once the activated interactive element goes back to its original state, that numeral will indicate an unread notification number that may be less than the unread notification number before the interactive element was activated, since some notifications may have been checked during the activation.

In yet another embodiment of the subject matter described herein, the user may select the notification displayed within the displaying area so as to cause more information, e.g. a full content of that notification to be displayed. For example, in a case that the application corresponding to the activated interactive element is a messaging application, the notification currently displayed within the activated interactive element may only comprise a sender's name and sending time. If the user is interested in the message indicated by this notification, then he/she may select this notification by double or multiple tapping on or long pressing it so that the full content of the notification, i.e. the message body, may be displayed. In this case, the full content may comprise text that scroll across the displaying area, e.g. automatically or responsive to the movement operation of the user on the display. In a case that the application corresponding to the activated interactive element is a telephone application, the notification currently displayed within the activated interactive element may only comprise a caller's name and calling time. If the user is interested, then he/she may select this notification by double or multiple tapping on or long pressing it so that more information of the notification, e.g. the caller's telephone number, may be displayed. Then, the user may dial back directly with the displayed telephone number without launching and accessing the telephone application.

In a further embodiment of the subject matter described herein, the notification may be displayed chronologically with a recently generated notification being displayed first.

By virtue of the method 500 according to the embodiments of the subject matter described above, users can view notifications associated with interested applications without launching and accessing the applications individually or switching among the applications. Furthermore, latest notifications from different applications are not lumped into one quick or fast access screen that may occupy the full area of the display, but neatly organized according to the corresponding interactive element's area on the electronic device.

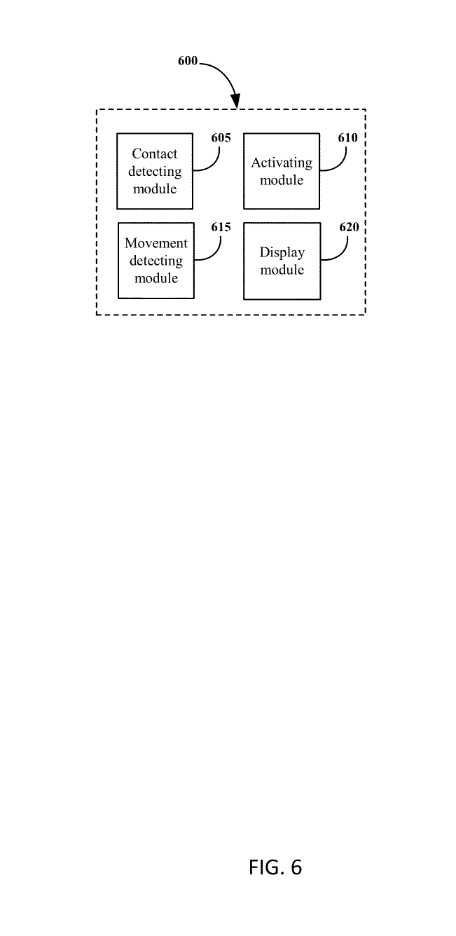

FIG. 6 illustrates a block diagram of an exemplary apparatus 600 for displaying notifications in an electronic device, e.g. the electronic device 100 as illustrated in FIG. 1, according to an embodiment of the subject matter described herein. The electronic device comprises a display on which an interactive elements corresponding to an application may be displayed. Specifically, in one embodiment, the display includes a touch-sensitive surface.

Generally, all the features discussed above with reference to the method 500 are applicable to the apparatus 600. Specifically, as illustrated, the apparatus 600 comprises an activating module 610 and a display module 620. In one embodiment, the apparatus 600 may further comprise a contact detecting module 605 configured to detect a contact operation of a user on the touch-sensitive surface, the contact operation targeted to an interactive element displayed on the display, said interactive element corresponding to an application in the electronic device. The activating module 610 is configured to activate an interactive element in response to the detected contact operation of a user on the interactive element.

In one embodiment, the apparatus 600 may further comprise a movement detecting module 615 configured to detect a movement operation of the user on the touch-sensitive surface. The display module 620 is configured to cause a notification associated with the application to be displayed within an area on the display, responsive to the detected movement operation of the user. This area for displaying the notification is smaller than a full area of the display.

In an embodiment of the subject matter described herein, the contact operation may be a continuous press over a predefined period of time or drawing of a predetermined pattern, as described above.

In another embodiment of the subject matter described herein, the displaying area may be an area within the activated interactive element, e.g. when the activated interactive element is a tile, or an area defined by expanding the activated interactive element or an area within a pop up window over the activated interactive element.

In a further embodiment of the subject matter described herein, the display module may further configured to cause the notification to be displayed for a predefined period of time after the movement operation is released.

Generally, various embodiments of the subject matter described herein may be implemented in hardware or special purpose circuits, software, logic or any combination thereof Some aspects may be implemented in hardware, while other aspects may be implemented in firmware or software which may be executed by a controller, microprocessor or other computing device. While various aspects of embodiments of the subject matter described herein are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof

By way of example, embodiments of the subject matter can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A method for displaying notifications in an electronic device that has a display , the method comprising:
activating an interactive element in response to a contact operation of a user on the interactive element, said interactive element corresponding to an application in the electronic device; and
responsive to a movement operation of the user on the display, causing a notification associated with the application to be displayed in an area on the display, wherein the area is smaller than a full area of the display.

2. The method according to claim 1, wherein the contact operation of the user on the interactive element comprises a continuous press on the interactive element over a predefined period of time.

3. The method according to claim 1, wherein the area comprises:
an area within the activated interactive element;
an area defined by expanding the activated interactive element; or
an area within a pop up window over the activated interactive element.

4. The method according to claim 1, wherein the movement operation comprises pressing and moving along an edge of the activated interactive element.

5. The method according to claim 1, wherein the causing a notification to be displayed comprises:
causing the notification to be displayed for a predefined period of time after the movement operation is released.

6. The method according to claim 1, further comprising:
causing a full content of the notification to be displayed upon selection of the notification by the user.

7. The method according to claim 1, wherein the causing at least partial content of a notification to be displayed comprises:
causing the notification to be displayed chronologically with a recently generated notification being displayed first.

8. The method according to claim 1, wherein
the notification comprises text that scrolls across the area.

9. An electronic device, comprising:
a display;
at least one processor;
at least one memory including computer program code, the at least one memory and the computer program code configured to, with the at least one processor, cause the electronic device to perform:
activating an interactive element in response to a contact operation of a user on the interactive element, said interactive element corresponding to an application in the electronic device; and
responsive to a movement operation of the user on the display, causing a notification associated with the application to be displayed in an area on the display, wherein the area is smaller than a full area of the display.

10. The electronic device according to claim 9, wherein the contact operation of the user on the interactive element comprises a continuous press on the interactive element over a predefined period of time.

11. The electronic device according to claim 9, wherein the area comprises:
an area within the activated interactive element;
an area defined by expanding the activated interactive element; or an area within a pop up window over the activated interactive element.

12. The electronic device according to claim 9, wherein the movement operation comprises pressing and moving along an edge of the activated interactive element.

13. The electronic device according to claim 9, wherein the at least one memory and the computer program code are configured to, with the at least one processor, cause the electronic device to further perform:
displaying the notification for a predefined period of time after the movement operation is released.

14. The electronic device according to claim 9, wherein the at least one memory and the computer program code are configured to, with the at least one processor, cause the electronic device to further perform:
displaying a full content of the notification upon selection of the notification by the user.

15. The electronic device according to claim 9, wherein the at least one memory and the computer program code are configured to, with the at least one processor, cause the electronic device to perform:
displaying the notification chronologically with a recently generated notification being displayed first.

16. The electronic device according to claim 9, wherein
the notification comprises text that scrolls across the area.

17. An apparatus for displaying notifications in an electronic device that has a display with a touch-sensitive surface, the apparatus comprising:
a contact detecting module configured to detect a contact operation of a user on the touch-sensitive surface, the contact operation targeted to an interactive element displayed on the display, said interactive element corresponding to an application in the electronic device;
an activating module configured to activate the interactive element in response to the contact operation of the user;
a movement detecting module configured to detect a movement operation of the user on the touch-sensitive surface; and
a display module configured to cause a notification associated with the application to be displayed in an area on the display in response to the movement operation, wherein the area is smaller than a full area of the display.

18. The apparatus according to claim 17, wherein the contact detecting module is configured to detect a continuous press on the interactive element over a predefined period of time.

19. The apparatus according to claim 17, wherein the area comprises:
an area within the activated interactive element;
an area defined by expanding the activated interactive element; or
an area within a pop up window over the activated interactive element.

20. The apparatus according to claim 17, wherein the display module is further configured to:
cause the notification to be displayed for a predefined period of time after the movement operation is released.
